(19) United States
(12) Patent Application Publication
(10) Pub. No.: US 2020/0062957 A1
(43) Pub. Date: Feb. 27, 2020

(54) Polyamide-based Composite Resin Composition Having Excellent Gas Barrier Property

(71) Applicants: Shinil Chemical Industry Co., Ltd., Gyeonggi-do (KR); Korea Fuel Tech Corporation, Gyeonggi-do (KR)

(72) Inventors: Keum-Suk Seo, Gyeonggi-do (KR); Dong Ryul Ryu, Chungcheongbuk-do (KR); Bo Ram Kwon, Gyeonggi-do (KR)

(73) Assignees: Shinil Chemical Industry Co., Ltd., Gyeonggi-do (KR); Korea Fuel Tech Corporation, Gyeonggi-do (KR)

(21) Appl. No.: 16/346,831

(22) PCT Filed: Oct. 20, 2017
(86) PCT No.: PCT/KR2017/011659

§ 371 Date: May 1, 2019

(30) Foreign Application Priority Data
Nov. 1, 2016 (KR) 10-2016-0144150

(51) Int. Cl. C08L 77/00; C08J 7/12; C08L 23/08; C08L 23/14; C08L 9/00; C08L 51/00; C08K 3/34; C08K 9/04; C08K 3/04; C08K 5/17; C08L 63/00; C08L 37/00

(52) U.S. Cl. CPC C08L 77/00; C08L 2203/30; C08L 23/0807; C08L 23/14; C08L 9/00; C08L 51/003; C08K 3/346; C08K 9/04; C08K 3/041; C08K 5/17; C08L 63/00; C08L 37/00; C08L 2201/14; C08L 2205/02; C08L 2205/03; C08J 7/12

(57) ABSTRACT

Provided is a polyamide-based composite resin composition which includes 30 to 80 wt % of a polyamide-based resin; 5 to 59 wt % of m-xylenediamine (MXD)-based modified nylon; 10 to 50 wt % of thermoplastic olefin rubber including a maleic anhydride-grafted ethylene-octene copolymer, a maleic anhydride-grafted ethylene-propylene-diene monomer, or a mixture thereof; 0.5 to 10 wt % of clay; and 0.01 to 5 wt % of carbon nanotubes (CNTs). According to the present invention, the polyamide-based composite resin composition is easily subjected to blow molding, is excellent in mechanical properties such as low-temperature impact strength and tensile strength, and is also capable of significantly enhancing a gas barrier property.

### TECHNICAL FIELD

The present invention relates to a polyamide-based composite resin composition, and more particularly, to a polyamide-based composite resin composition which is easily subjected to blow molding, is excellent in mechanical properties such as low-temperature impact strength and tensile strength, and is also capable of significantly enhancing a gas barrier property.

### BACKGROUND ART

Recently, the need for technical improvement of fuel injection pipes is gradually increasing. It is necessary to respond to the strengthening of regulations for evaporative gas, the need for the use of lightweight materials has arisen in accordance with regulations for CO₂, and it also is necessary to satisfy affinity for biofuels.

Plastic materials are suitable as lightweight materials. However, due to the changes in composition of gasoline fuel caused by addition of bioethanol, barrier properties against alcohol gas have been pointed out as a problem. Since the material of the injection part of an existing fuel tank contains nylon and rubber, it has a good barrier property against gasoline, but has a drawback of a poor barrier property against alcohol.

In addition, as the legal regulations for evaporative gas have been strengthened, there is a need to develop materials with an excellent barrier property. For example, evaporative gas has been regulated at the limit of 10 mg or less (F/Neck Ass'y 30 mg) with respect to EO in Korea, 100 mg (EURO IV) with respect to E10 in Europe, and 2.5 mg (level III regulated by EPA) with respect to E10 in North America.

Meanwhile, since high-density polyethylene (HDPE) that is commonly used as a resin for blow molding has a poor fuel barrier property of 68 g·mm/m²/day, it can be used in the form of a multilayer structure with an ethylene vinyl alcohol (EVOH) copolymer. However, in order to form a multilayer structure, there are disadvantages in that an expensive multiple-extrusion apparatus needs to be used, and designability for achieving satisfactory blow extrudability is required.

Considering the above-described problems, it is possible to use nylon-based resins having an excellent barrier property. However, polyamide 6 among nylon-based resins has an excellent barrier property against gasoline, but does not have satisfactory low-temperature impact strength.

Korean Registered Patent No. 10-1002050 discloses a multilayer article with a barrier property, which includes a polyolefin layer and a nanocomposite blend layer with a barrier property, in which a polyolefin resin is dispersed in the continuous phase of a nanocomposite of a resin with a barrier property and a layered clay compound. However, this has a disadvantage in that a special screw is required to prepare a polyamide dispersion layer in a polyethylene resin, and it is difficult to efficiently control morphology during blow molding.

Korean Unexamined Patent Publication No. 10-2011-0012430 discloses a polyamide resin/clay composite composition including a base resin including a polyamide resin and a polyolefin resin, an olefin-based oligomer, and a layered clay compound. However, this has a disadvantage in that the control of a polyamide dispersion layer is very difficult during blow molding, a large amount of a compatibilizer needs to be added in a polyolefin resin, and the blockage of gas and gasoline is decreased due to the difficulty of controlling morphology.

US Patent Publication No. 2011-0217495 discloses a blow molding material including a thermoplastic molding material consisting of polyamide-6, a nanofiller, a fibrous filler, an impact modifier, and polyamide-66. However, this has a disadvantage in that the addition of an inorganic material (fibrous filler) leads to degradation of impact strength, and an increase in drawing stress leads to degradation of drawability, thereby blow molding is not easily performed. Therefore, it is required to develop a material applicable to a part of the injection part of a fuel tank, which is easily subjected to blow molding and is capable of enhancing high impact strength, tensile strength, and a gas barrier property.

### PRIOR-ART DOCUMENTS

Korean Registered Patent No. 10-1002050

Korean Unexamined Patent Publication No. 10-2011-0012430

US Patent Publication No. 2011-0217495

Korean Registered Patent No. 10-0998619

### DISCLOSURE

### Technical Problem

The present invention has been made to solve the above-described problems, and an objective of the present invention is to provide a polyamide-based composite resin composition which is easily subjected to blow molding and is excellent in mechanical properties such as low-temperature impact strength and tensile strength.

Another objective of the present invention is to provide a polyamide-based composite resin composition which is capable of significantly enhancing a gas barrier property against a mixed fuel of gasoline and alcohol as well as gasoline.

### Technical Solution

According to the present invention, there is provided a polyamide-based composite resin composition which includes 30 to 80 wt % of a polyamide-based resin; 5 to 59 wt % of m-xylenediamine (MXD)-based modified nylon; 10 to 50 wt % of thermoplastic olefin rubber including a maleic anhydride-grafted ethylene-octene copolymer, a maleic anhydride-grafted ethylene-propylene-diene monomer, or a mixture thereof; 0.5 to 10 wt % of clay; and 0.01 to 5 wt % of carbon nanotubes (CNTs), wherein the polyamide-based resin has a relative viscosity (RV) ranging from 2.0 to 3.4.

The polyamide-based composite resin composition may further include 0.01 to 5 wt % of conductive carbon black.

The polyamide-based composite resin composition may further include 0.05 to 2.0 wt % of a heat stabilizer, 0.05 to 3.0 wt % of a lubricant, and 0.05 to 3.7 wt % of a viscosity enhancer.

The m-xylenediamine (MXD)-based modified nylon may include m-xylenediamine 6 nylon.

The m-xylenediamine (MXD)-based modified nylon may further include one or more selected from aromatic nylon and amorphous nylon, and the aromatic nylon and the amorphous nylon are preferably included in an amount of 0.01 to 30 wt % in the m-xylenediamine (MXD)-based modified nylon.

The clay is preferably mixed clay formed by mixing two or more selected from platy montmorillonite, hectorite, saponite, and vermiculite and organically pretreating the mixture.

The organically pretreated mixed clay may be formed by pre-treatment with an organic material including tertiary or quaternary ammonium. The organic material may include one or more ammoniums selected from bis(2-hydroxy-ethyl)methyl tallow ammonium and dimethyl hydrogenated-tallow ammonium.

The organically pretreated mixed clay may be formed by pre-treatment with an organic material including any one or more functional groups selected from phosphonium, maleate, succinate, acrylate, benzylic hydrogen, dimethyl distearyl ammonium, and oxazoline.

The polyamide-based resin preferably includes polyamide 6.

The polyamide-based resin may further include one or more resins selected from a maleic acid-based resin and an epoxy-based resin to increase a molecular weight, a molecular weight is adjusted by an extrusion reaction between a —NH functional group at the end of polyamide and a resin including a maleic acid- or epoxy-based resin, and the one or more resins selected from a maleic acid-based resin and an epoxy-based resin are preferably included in an amount of 0.01 to 15 wt % in the polyamide-based resin.

The polyamide-based resin may include aromatic nylon to improve a gas barrier property, and the aromatic nylon is preferably included in an amount of 0.01 to 15 wt % in the polyamide-based resin.

### Advantageous Effects

A polyamide-based composite resin composition according to the present invention is easily subjected to blow molding, is excellent in mechanical properties such as low-temperature impact strength and tensile strength, and is also capable of significantly enhancing a gas barrier property against a mixed fuel of gasoline and alcohol as well as gasoline.

The polyamide-based composite resin composition according to the present invention can be used as a composite resin for a fuel injection pipe requiring mechanical properties such as low-temperature impact strength, tensile strength, etc. and a gas barrier property.

Effects of the present invention are not limited to the above-described effects and it should be understood that all effects that can be inferred from a configuration of the present invention disclosed herein are encompassed.

### DESCRIPTION OF DRAWINGS

FIG. 1 is a transmission electron microscope (TEM) image of a polyamide-based composite resin prepared according to Example 1.

FIG. 2 is a scanning electron microscope (SEM) image of a polyamide-based composite resin prepared according to Example 2.

FIG. 3 illustrates results of measuring the residual fuel permeability of molded articles fabricated using polyamide-based composite resins prepared according to Examples 2 and 3 and Comparative Example 1.

FIG. 4 is an image of a fuel oil container used in the evaluation of a gas barrier property.

### BEST MODE

A polyamide-based composite resin composition according to a preferred embodiment of the present invention includes 30 to 80 wt % of a polyamide-based resin; 5 to 59 wt % of m-xylenediamine (MXD)-based modified nylon; 10 to 50 wt % of thermoplastic olefin rubber including a maleic anhydride-grafted ethylene-octene copolymer, a maleic anhydride-grafted ethylene-propylene-diene monomer, or a mixture thereof; 0.5 to 10 wt % of clay; and 0.01 to 5 wt % of carbon nanotubes (CNTs), wherein the polyamide-based resin has a relative viscosity (RV) ranging from 2.0 to 3.4.

### MODES OF THE INVENTION

In the specification, when a component is referred to as “containing”, “including”, “comprising”, or “having” another component, it is to be understood that the component may include other components as well, unless specifically stated otherwise.

The polyamide-based composite resin composition according to a preferred embodiment of the present invention includes 30 to 80 wt % of a polyamide-based resin; 5 to 59 wt % of m-xylenediamine (MXD)-based modified nylon; 10 to 50 wt % of thermoplastic olefin rubber including a maleic anhydride-grafted ethylene-octene copolymer, a maleic anhydride-grafted ethylene-propylene-diene monomer, or a mixture thereof; 0.5 to 10 wt % of clay; and 0.01 to 5 wt % of carbon nanotubes (CNTs), wherein the polyamide-based resin has a relative viscosity (RV) ranging from 2.0 to 3.4.

The polyamide-based composite resin composition may further include 0.01 to 5 wt % of conductive carbon black.

The polyamide-based composite resin composition may further include 0.05 to 2.0 wt % of a heat stabilizer, 0.05 to 3.0 wt % of a lubricant, and 0.05 to 3.7 wt % of a viscosity enhancer.

The m-xylenediamine (MXD)-based modified nylon may include m-xylenediamine 6 nylon.

The m-xylenediamine (MXD)-based modified nylon may further include one or more selected from aromatic nylon and amorphous nylon, and the aromatic nylon and the amorphous nylon are preferably included in an amount of 0.01 to 30 wt % in the m-xylenediamine (MXD)-based modified nylon.

The clay is preferably mixed clay formed by mixing two or more selected from platy montmorillonite, hectorite, saponite, and vermiculite and organically pretreating the mixture.

The organically pretreated mixed clay may be formed by pre-treatment with an organic material including tertiary or quaternary ammonium. The organic material may include one or more ammoniums selected from bis(2-hydroxy-ethyl)methyl tallow ammonium and dimethyl hydrogenated-tallow ammonium.

The organically pretreated mixed clay may be formed by pre-treatment with an organic material including any one or more functional groups selected from phosphonium, maleate, succinate, acrylate, benzylic hydrogen, dimethyl distearyl ammonium, and oxazoline.

The polyamide-based resin preferably includes polyamide 6. The polyamide-based resin may further include one or more resins selected from a maleic acid-based resin and an epoxy-based resin to increase a molecular weight, a molecular weight is adjusted by an extrusion reaction between a —NH functional group at the end of polyamide and a resin including a maleic acid- or epoxy-based resin, and the one or more resins selected from a maleic acid-based resin and an epoxy-based resin are preferably included in an amount of 0.01 to 15 wt % in the polyamide-based resin.

The polyamide-based resin may include aromatic nylon to improve a gas barrier property, and the aromatic nylon is preferably included in an amount of 0.01 to 15 wt % in the polyamide-based resin.

Hereinafter, the polyamide-based composite resin composition according to a preferred embodiment of the present invention will be described in more detail. The polyamide-based composite resin composition according to a preferred embodiment of the present invention includes 30 to 80 wt % of a polyamide-based resin having a relative viscosity (RV) ranging from 2.0 to 3.4; 5 to 59 wt % of m-xylenediamine (MXD)-based modified nylon; 10 to 50 wt % of thermoplastic olefin rubber including a maleic anhydride-grafted ethylene-octene copolymer, a maleic anhydride-grafted ethylene-propylene-diene monomer, or a mixture thereof; 0.5 to 10 wt % of clay; and 0.01 to 5 wt % of carbon nanotubes (CNTs).

The polyamide-based composite resin composition includes a polyamide-based resin. A polyamide resin generally has a glass transition temperature of 47° C. and a melting temperature of 220° C., and is represented by the molecular formula C₆H₁₁ON. A polyamide has an amorphous density of 1.084 g/cm³ at 25° C. and a crystalline density of 1.23 g/cm³ at 25° C. The repeat unit structure of polyamide is as follows.

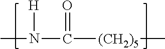

The polyamide-based resin preferably includes polyamide 6. The polyamide 6, which is the nylon 6 including a diamine and a dicarboxylic acid, exhibits a relatively excellent barrier property against gasoline of 5 g·mm/m²/day and is excellent in mechanical properties, chemical resistance, and heat resistance. As the polyamide 6, Grivoly BRZ 350 commercially available from EMS or Technyl C544 commercially available from Rhodia may be used.

The polyamide-based resin is preferably included in an amount of 30 to 80 wt % in the polyamide-based composite resin composition. When the content of the polyamide-based resin is less than 30 wt %, an effect of improving chemical resistance and heat resistance may be insignificant, and when the content of the polyamide-based resin is greater than 80 wt %, room-temperature impact strength, low-temperature impact strength, and blow moldability may be deteriorated.

The polyamide-based resin preferably has a relative viscosity (RV) ranging from 2.0 to 3.4. A polyamide-based resin having an RV of 2.0 or more in a sulfuric acid solution is preferably used. This is because the use of a polyamide-based resin having an RV of less than 2.0 leads to increased fluidity, and thus blow molding may not be performed due to the problem of fluidity in a parison in the case of extrusion blow molding.

The polyamide-based resin may further include one or more resins selected from a maleic acid-based resin and an epoxy-based resin to increase a molecular weight. The addition of a maleic acid-based resin or an epoxy-based resin may allow a molecular weight to be adjusted by an extrusion reaction between a -NH functional group at the end of polyamide and a resin including a maleic acid- or epoxy-based resin. The one or more resins selected from a maleic acid-based resin and an epoxy-based resin are preferably included in an amount of 0.01 to 15 wt % in the polyamide-based resin. When the content of the one or more resins selected from a maleic acid-based resin and an epoxy-based resin is less than 0.01 wt %, viscosity is not enhanced due to a weak effect of adjusting a molecular weight, and thus blow moldability is deteriorated. When the content thereof is greater than 15 wt %, viscosity is excessively enhanced, and thus blow molding is not performed, thereby moldability may rather be deteriorated.

The polyamide-based resin may partially include aromatic nylon with an excellent gas barrier property. To improve a gas barrier property, the aromatic nylon is preferably included in an amount of 0.01 to 15 wt % in the polyamide-based resin. When the content of the aromatic nylon is less than 0.01 wt %, an effect of improving a gas barrier property may be insignificant, and even if the content of the aromatic nylon is greater than 15 wt %, an effect of improving a gas barrier property may not increase as much as the addition amount.

The polyamide-based composite resin composition includes m-xylenediamine (MXD)-based modified nylon. The MXD-based modified nylon is a material constituting a dispersion layer, may be modified nylon having a melt index (MI) of 0.5 as measured at 275° C., and exhibits an excellent gas barrier property by forming a dispersion layer with a laminar structure when mixed with the polyamide-based resin. Since such a dispersion layer may be sensitively changed according to a molding temperature, it is necessary to adjust a molding temperature to 275° C. or less (e.g., 220 to 275° C.). The MXD-based modified nylon may be m-xylenediamine 6 nylon, and may further include one or more selected from aromatic nylon and amorphous nylon. The aromatic nylon and the amorphous nylon are preferably included in an amount of 0.01 to 30 wt % in the MXD-based modified nylon. The MXD-based modified nylon is preferably included in an amount of 5 to 59 wt % in the polyamide-based composite resin composition. When the content of the MXD-based modified nylon is less than 5 wt %, it is difficult to form a laminar structure for increasing a gas barrier property against a mixed fuel of gasoline and alcohol as well as gasoline, and thus an effect of improving a gas barrier property may be insignificant. When the content of the MXD-based modified nylon is greater than 59 wt %, mechanical properties may be deteriorated.

The polyamide-based composite resin composition includes thermoplastic olefin (TPO) rubber. The TPO rubber includes a maleic anhydride-grafted ethylene-octene copolymer, a maleic anhydride-grafted ethylene-propylene-diene monomer, or a mixture thereof The maleic anhydride-grafted ethylene-octene copolymer, the maleic anhydride-grafted ethylene-propylene-diene monomer, or the mixture thereof is a type of TPO rubber. The TPO rubber may be added to enhance dispersibility through a reaction with the chain of the polyamide-based resin. Compared to an existing ethylene-propylene-diene monomer (EPDM), the maleic anhydride-grafted ethylene-octene copolymer, the maleic anhydride-grafted ethylene-propylene-diene monomer, or the mixture thereof may increase dispersibility to reduce the size of a pore. Therefore, even if a small amount thereof is used, impact resistance may be ensured, and a laminar structure that blocks gas permeation may not be disturbed.

The TPO rubber including a maleic anhydride-grafted ethylene-octene copolymer, a maleic anhydride-grafted ethylene-propylene-diene monomer, or a mixture thereof may be dispersed using a twin screw compressor in such a way that the size is 1 to 10 um. The TPO rubber including a maleic anhydride-grafted ethylene-octene copolymer, a maleic anhydride-grafted ethylene-propylene-diene monomer, or a mixture thereof is preferably included in an amount of 10 to 50 wt % in the polyamide-based composite resin composition. Specifically, when the content of the TPO rubber is less than 10 wt %, an effect of improving low-temperature impact strength may be insignificant, and when the content of the TPO rubber is greater than 50 wt %, impact resistance may be improved, but properties other than impact resistance may be deteriorated.

The polyamide-based composite resin composition includes clay. The clay is an inorganic filler that reinforces the gas barrier property of a matrix resin, and may be a microparticle having a size of 0.1 to 10 nm. The clay may be platy montmorillonite, hectorite, saponite, or vermiculite, and is more preferably platy montmorillonite, hectorite, saponite, or vermiculite, which has been organically pretreated with an organic material.

The organic material may be an organic material including tertiary or quaternary ammonium. The organic material may include one or more ammoniums selected from bis(2-hydroxy-ethyl)methyl tallow ammonium and dimethyl hydrogenated-tallow ammonium. For example, montmorillonite organically treated with bis(2-hydroxy-ethyl)methyl tallow ammonium or montmorillonite organically treated with dimethyl hydrogenated-tallow ammonium may be used as the clay.

The organic material may be an organic material including any one functional group selected from phosphonium, maleate, succinate, acrylate, benzylic hydrogen, dimethyl distearyl ammonium, and oxazoline.

The clay may be mixed clay formed by mixing two or more types of clay selected from platy montmorillonite, hectorite, saponite, and vermiculite, and is more preferably mixed clay formed by mixing two or more types of clay selected from platy montmorillonite, hectorite, saponite, and vermiculite and organically pretreating the mixture. The organically pretreated mixed clay may be formed by mixing two or more types of clay in a reaction tank in preparation of clay and then pretreating the resultant mixture with an organic material.

Since the mixed clay has enhanced dispersibility in the resin compared to a single clay, the use of only a small amount of the organic material, which has been used in the treatment in a much larger amount than what is appropriate for an exchange reaction during the organic pretreatment for helping dispersion, results in enhanced heat stability in the polyamide-based composite resin composition, and thus a problem of gas generated during blow molding may be resolved.

The clay is used in an amount of 0.5 to 10 wt %. When the content of the clay is less than 0.5 wt %, an effect of improving a gas barrier property may be insignificant, and when the content of the clay is greater than 10 wt %, tensile strength and flexural strength rapidly increase, and an elongation rate is degraded, thereby impact strength may be deteriorated.

The polyamide-based composite resin composition may further include 0.05 to 2.0 wt % of a heat stabilizer. The heat stabilizer may impart a function of maintaining long-term heat resistance, and may include one or more materials selected from halides of Group I metal of the Periodic Table, such as sodium halides, potassium halides, and lithium halides, cuprous halides, and cuprous iodine compounds. As the heat stabilizer, one or more materials selected from hindered phenols, hydroquinone, and aromatic amines may be used. When the content of the heat stabilizer is less than 0.05 wt %, an effect of improving long-term heat resistance may be insignificant, and even if the content of the heat stabilizer is greater than 2.0 wt %, long-term heat resistance may not increase as much as the addition amount.

The polyamide-based composite resin composition may further include 0.05 to 3.0 wt % of a lubricant. The lubricant may act as an internal lubricant to induce a smooth flow during an injection process, and may include one or more materials selected from stearic acid, stearyl alcohol, and stearamide. When the content of the lubricant is less than 0.05 wt %, a function of inducing a smooth flow during an injection process may be insignificant, and even if the content of the lubricant is greater than 3.0 wt %, lubricity may not increase as much as the addition amount.

The polyamide-based composite resin composition may further include 0.05 to 3.7 wt % of a viscosity enhancer. The viscosity enhancer may serve to increase the viscosity of the polyamide-based composite resin composition at an extrusion temperature such that viscosity suitable for blow molding is exhibited. As the viscosity enhancer, one or more selected from vinyl-based, epoxy-based, methacryloxy-based, amino-based, mercapto-based, acryloxy-based, isocyanate-based, styryl-based, and alkoxy oligomer-based materials may be used. When the content of the viscosity enhancer is less than 0.05 wt %, a viscosity enhancing effect may be insignificant, and when the content of the viscosity enhancer is greater than 3.7 wt %, blow moldability may be deteriorated.

The polyamide-based composite resin composition may further include 0.01 to 5 wt % of conductive carbon black. The conductive carbon black may be carbon black masterbatch (CB/MB) and acts as a filler. When conductive carbon black is added, mechanical properties such as tensile strength (TS) and an antistatic property for preventing static electricity may be enhanced. When the content of the conductive carbon black is less than 0.01 wt %, property improvement effects may be insignificant, and even if the content of the conductive carbon black is greater than 5%, properties may not be improved as much as the addition amount.

The polyamide-based composite resin composition may include 0.01 to 5 wt % of carbon nanotubes (CNTs). The CNTs are in the form in which hexagonal networks consisting of carbon atoms are rolled. In this case, according to the rolling angle, the end portion has a zigzag shape or an armchair shape. Also, the rolled form has a single-walled structure with a single wall or a multi-walled structure with a plurality of walls. In addition to these forms, the CNTs are in the form of nanotube bundles in which single-walled or multi-walled CNTs are bundled, metal-atom-filled nanotubes in which metal atoms are present inside the tube, etc. When CNTs are added, mechanical properties such as flexural modulus (FM), flexural strength (FS), and tensile strength (TS) and heat-resistant properties such as heat deflection temperature (HDT) may be enhanced. When the content of the CNTs is less than 0.01 wt %, property improvement effects may be insignificant, and even if the content of the CNTs is greater than 5%, properties may not increase as much as the addition amount.

The above-described polyamide-based composite resin composition according to the present invention is easily subjected to blow molding, is excellent in mechanical properties such as low-temperature impact strength and tensile strength, and also has a high gas barrier property against a mixed fuel of gasoline and alcohol as well as gasoline.

Hereinafter, Examples according to the present invention and Comparative Examples will be provided in detail, but the present invention is not limited by the following Examples and Comparative Examples.

### PREPARATION EXAMPLE

### Preparation of Organically Pretreated Mixed Clay

Montmorillonite and hectorite, in a weight ratio of 1:1 and from which impurities had been removed, were added to water and mixed while stirring at 60° C. to prepare a mixed clay dispersion. The mixed clay dispersion were put into a reaction tank, the pH was adjusted to a range of 4 to 5, then dimethyl hydrogenated-tallow ammonium, which is tertiary ammonium which melts at 60° C., was added in an amount of 90 milliequivalants per 100 g of mixed clay, and the mixture was subjected to an exchange reaction at 60° C. for 20 to 60 minutes while stirring to prepare organically pretreated mixed clay. The organically pretreated mixed clay was selectively separated using a filter apparatus, then dried in a fluid dryer, and pulverized using a milling apparatus to obtain powder having a particle size of 10 to 40 μm.

Examples 1 to 3>and <Comparative Examples 1 to 7

For Examples 1 to 3 and Comparative Examples 1 to 7, components were mixed in the ratios shown in Table 1 below and then extruded using an extruder to prepare a polyamide-based composite resin composition. Comparative Examples are presented merely for comparison with the characteristics of Examples and are not prior art of the present invention.

As the extruder, the continuous extruder disclosed in Korean Registered Patent No. 10-0998619 was used. A polyamide-based resin, m-xylenediamine (MXD)-based modified nylon, thermoplastic olefin (TPO) rubber, a heat stabilizer, a lubricant, a viscosity enhancer, and conductive carbon black were added through a main feeder, and Clay 1 and Clay 2 (the organically pretreated mixed clay prepared according to Preparation Example) were added through a side feeder. Since clay may be entangled when clay is put into a main feeder (hopper), clay is preferably added through a side feeder (side feeding inlet) or by a spraying method. As the screw of the extruder, a unit capable of disorderly mixing may be used to enhance dispersibility. Also, it is preferable to keep the extrusion temperature in a mixing region to 275° C. or less. When the extrusion temperature is higher than 275° C., a domain size is miniaturized, and thus a barrier property may be deteriorated. The polyamide-based composite resin composition thus mixed was pelletized with a cutter, and then dried using a dehumidifying dryer to prepare a polyamide-based composite resin.

TABLE 1

| | Comparative Examples | | | | | | | Examples | | |
|---|---|---|---|---|---|---|---|---|---|---|
| Classification | 1 | 2 | 3 | 4 | 5 | 6 | 7 | 1 | 2 | 3 |
| Nylon 6 | 68 | 69 | 59 | 65 | 43 | 50 | 67 | 57 | 65 | 60 |
| MXD 6 | — | — | — | — | 30 | 23 | 3 | 10 | 10 | 10 |
| Nylon 6T | 10 | — | 10 | — | — | — | — | — | — | — |
| Rubber | — | — | — | — | — | — | — | 17 | — | — |
| Rubber-g-MA | 20 | 26 | 26 | 31 | 25 | 25 | 25 | 12 | 20 | 25 |
| Clay 1 | — | 3 | 3 | 2 | — | — | — | — | — | — |
| Clay 2 | — | — | — | — | — | — | 3 | 2 | 3 | 3 |
| Heat stabilizer | 0.4 | 0.4 | 0.4 | 0.4 | 0.4 | 0.4 | 0.4 | 0.4 | 0.4 | 0.4 |
| Lubricant | 0.4 | 0.4 | 0.4 | 0.4 | 0.4 | 0.4 | 0.4 | 0.4 | 0.4 | 0.4 |
| Viscosity | 0.6 | 0.6 | 0.6 | 0.6 | 0.6 | 0.6 | 0.6 | 0.6 | 0.6 | 0.6 |
| enhancer | | | | | | | | | | |
| Conductive | 0.6 | 0.6 | 0.6 | 0.6 | 0.6 | 0.6 | 0.6 | 0.6 | 0.6 | 0.6 |
| carbon black | | | | | | | | | | |

(Units: wt %)
Nylon 6: Polyamide 6 (polyamide-based resin)
MXD 6: m-Xylenediamine (MXD) 6 nylon (m-xylenediamine-based modified nylon)
Nylon 6T: Polyhexamethylene terephthalamide 6T
Rubber: Ethylene-octene copolymer
Rubber-g-MA: Maleic anhydride-grafted ethylene-octene copolymer
Clay 1: Montmorillonite clay
Clay 2: Mixed clay formed by mixing montmorillonite and hectorite in a weight ratio of 1:1 and organically pretreating the mixture
Heat stabilizer: Mixture of cuprous halide and metal halide
Lubricant: Stearamide
Viscosity enhancer: Epoxy resin
Conductive carbon black: Carbon black masterbatch (CB/MB)

### EXPERIMENTAL EXAMPLE 1

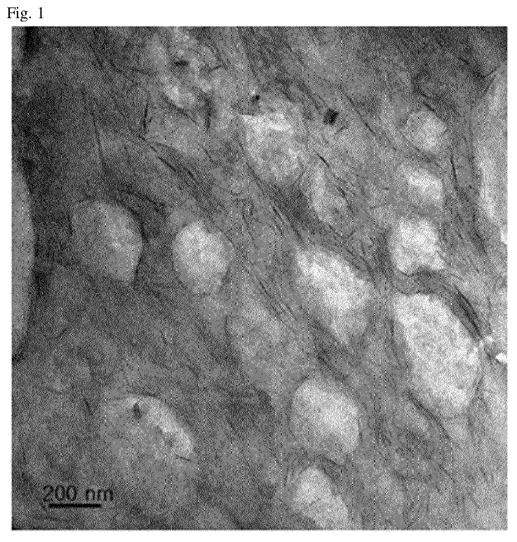

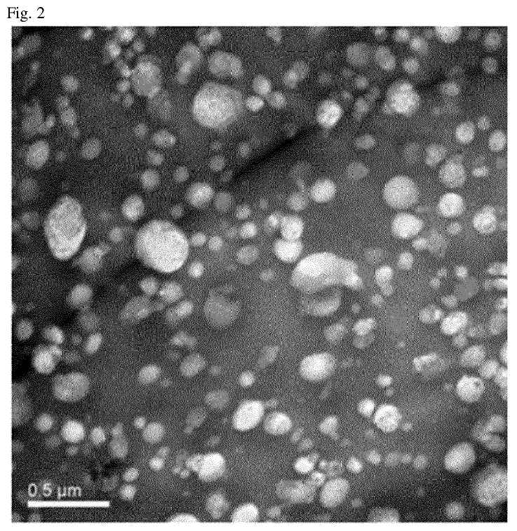

To examine the properties, processabilities, gas barrier properties, and the like of molded articles fabricated using the polyamide-based composite resins prepared according to Examples 1 to 3 and Comparative Examples 1 to 7, the following items were measured, and results thereof are shown in Tables 2 and 3 below and FIGS. 1 and 2.

(1) Tensile strength (MPa): measured at 50 mm/min in accordance with ASTM D638.

(2) Flexural modulus (MPa): measured at 3 mm/min in accordance with ASTM D790.

(3) IZOD impact strength (kJ/m²): measured at a low temperature of −30° C. under a ¼″ notched condition in accordance with ASTM D256.

(4) Heat deflection temperature (° C.): measured while applying a surface pressure of 0.45 MPa in accordance with ASTM D648.

(5) Bending evaluation: The sample was bent back and forth ten times in a bending machine and then evaluated.

(6) Low-temperature drop evaluation: The sample was allowed to stand at a low temperature of −40° C. for 3 hours and, within 30 seconds thereafter, freely fall from a height of 1 m, and then whether or not cracking occurred was evaluated.

(7) Barrier property evaluation: The sample was loaded into a fuel oil container (FIG. 4) and weight variation over time was measured at 60° C. in accordance with SAE J2665.

TABLE 2

| | Comparative Examples | | | | | | | Examples | | |
|---|---|---|---|---|---|---|---|---|---|---|
| Classification | 1 | 2 | 3 | 4 | 5 | 6 | 7 | 1 | 2 | 3 |
| Density | 1.06 | 1.06 | 1.06 | 1.04 | 1.05 | 1.06 | 1.06 | 1.04 | 1.04 | 1.05 |
| Tensile strength | 49 | 46 | 44 | 43 | 44 | 43 | 54 | 55 | 59 | 61 |
| (MPa) | | | | | | | | | | |
| Flexural modulus | 1916 | 1728 | 1655 | 1596 | 1356 | 1442 | 1819 | 1651 | 1651 | 1789 |
| (MPa) | | | | | | | | | | |
| Izod impact | 129 | 130 | 187 | 184 | 62 | 73 | 113 | 209 | 211 | 331 |
| strength (−30° C.) | | | | | | | | | | |
| [kJ/m²] | | | | | | | | | | |
| Heat deflection | 180 | 181 | 168 | 181 | 58 | 62 | 174 | 185 | 185 | 186 |
| temperature [° C.] | | | | | | | | | | |

TABLE 3

| | Comparative Examples | | | | Examples | | |
|---|---|---|---|---|---|---|---|
| Classification | 1 | 2 | 3 | 4 | 1 | 2 | 3 |
| Bending evaluation | Pass | NG | Pass | NG | Pass | Pass | Pass |
| Low-temperature drop | Pass | Pass | Pass | NG | Pass | Pass | Pass |
| evaluation | | | | | | | |
| Gas barrier property | 15.2 | 25.0 | 30.5 | 32.5 | 2.5 | 2.7 | 2.0 |
| evaluation (g · mm/ | | | | | | | |
| m²/day) | | | | | | | |

The results of Tables 2 and 3 show that Comparative Example 1, in which MXD-based modified nylon and clay were not added, exhibited a poor low-temperature impact strength of 129 kJ/m², and Comparative Examples 2 to 4, in which MXD-based modified nylon was not added, exhibited poor properties, particularly, in terms of low-temperature impact strength and tensile strength, and also exhibited poor results in the bending and gas barrier property evaluations. In addition, in the case of Comparative Examples 5 and 6 in which polyamide 6 and MXD 6 were included, but clay was not added, particularly, the values of impact strength and heat deflection temperature were significantly decreased.

Additionally, in the case of Comparative Example 7 in which a small amount of MXD 6 was included, tensile strength and flexural modulus were relatively excellent, but impact strength and heat deflection temperature were slightly lower compared to Examples 1 to 3.

On the other hand, in the case of Examples 1 to 3 in which polyamide 6, MXD 6, a maleic anhydride-grafted ethylene-octene copolymer, and mixed clay were included, particularly, tensile strength and low-temperature impact strength were significantly enhanced, and flexural modulus and heat deflection temperature also were excellent. Also, Examples 1 to 3 exhibited good results in the evaluation of a gas barrier property, and this is because the mixed clay uniformly dispersed on rubber and nylon results in an excellent gas barrier property.

FIG. 1 is a transmission electron microscope (TEM) image of the polyamide-based composite resin prepared according to Example 1.

As shown in FIG. 1, it can be confirmed that organically pretreated mixed clay was dispersed in the polyamide-based resin.

FIG. 2 is a scanning electron microscope (SEM) image of the polyamide-based composite resin prepared according to Example 2.

As shown in FIG. 2, it can be confirmed that MXD 6 (m-xylenediamine (MXD)-based modified nylon) was uniformly dispersed in the maleic anhydride-grafted ethylene-octene copolymer (thermoplastic olefin rubber).

### EXPERIMENTAL EXAMPLE 2

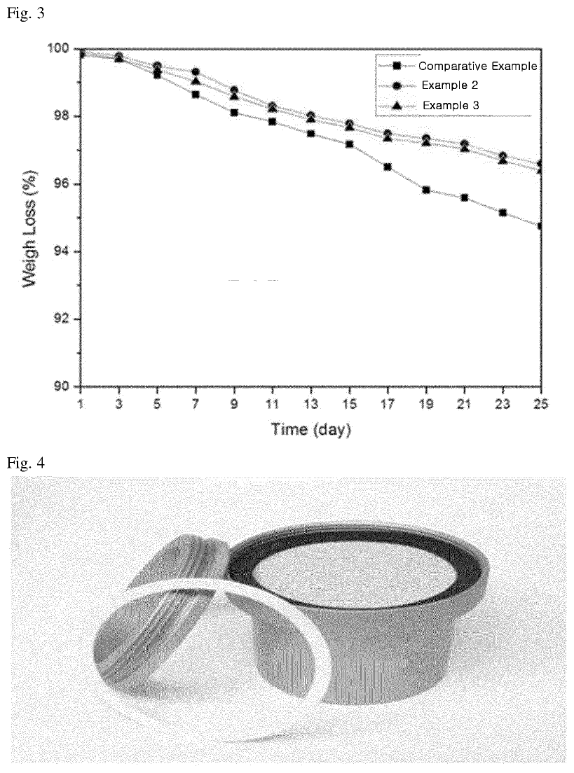

To examine the permeabilities of molded articles fabricated using the polyamide-based composite resins prepared according to Examples 2 and 3 and Comparative Example 1, E10 fuel was injected, residual fuel permeability was then measured at a chamber temperature of 60° C. in accordance with SAE J2665, and results thereof are shown in FIG. 3. Although residual fuel permeability is generally expressed as weight/thickness/time, no separate indication of thickness was provided in the graph of FIG. 3 because samples having the same thickness were used.

FIG. 3 illustrates results of measuring residual fuel permeabilities of molded articles fabricated using polyamide-based composite resins prepared according to Examples 2 and 3 and Comparative Example 1.

As shown in FIG. 3, it can be confirmed that Examples 2 and 3 exhibited further enhanced residual fuel permeability compared to Comparative Example 1. In consideration of this, it is determined that fuel permeability is enhanced by uniformly forming a layer with a laminar structure due to the addition of MXD 6 (m-xylenediamine (MXD)-based modified nylon), a maleic anhydride-grafted ethylene-octene copolymer (thermoplastic olefin rubber), and clay to polyamide 6 (polyamide-based resin).

As described above, the polyamide-based composite resin compositions prepared according to Example 1 to 3 includes a polyamide-based resin, m-xylenediamine (MXD)-based modified nylon, thermoplastic olefin rubber, and clay, so that it is easily subjected to blow molding, is excellent in mechanical properties such as low-temperature impact strength and tensile strength, and is also capable of significantly enhancing a gas barrier property.

The present invention has been described in detail with reference to preferred examples of the present invention but is not limited to the examples.

### INDUSTRIAL APPLICABILITY

A polyamide-based composite resin composition according to the present invention is easily subjected to blow molding, is excellent in mechanical properties such as low-temperature impact strength and tensile strength, and is also capable of significantly enhancing a gas barrier property against a mixed fuel of gasoline and alcohol as well as gasoline. Therefore, the present invention has industrial applicability.

1. A poiyamide-based composite resin composition comprising:
30 to 80 wt % of a polyamide-based resin;
5 to 59 wt % of m-xylenediamine (MXD)-based modified nylon;
10 to 50 wt % of thermoplastic olefin rubber including a maleic anhydride-grafted ethylene-octene copolymer, a maleic anhydride-grafted ethylene-propylene-diene monomer, or a mixture thereof;
0.5 to 10 wt % of clay; and
0.01 to 5 wt % of carbon nanotubes (CNTs),
wherein the polyamide-based resin has a relative viscosity (RV) ranging from 2.0 to 3.4.

2. The polyimide-based composite resin composition of claim 1, further comprising 0.01 to 5 wt % of conductive carbon black.

3. The polyamide-based composite resin composition of claim 1, further comprising 0.05 to 2.0 wt % of a heat stabilizer, 0.05 to 3.0 wt % of a lubricant, and 0.05 to 3.7 wt % of a viscosity enhancer.

4. The polyamide-based composite resin composition of claim 1, wherein the m-xylenediamine (MXD)-based modified nylon includes m-xylenediamine 6 nylon.

5. The polyamide-based composite resin composition of claim 1, wherein the m-xylenediamine (MXD)-based modified nylon further includes one or more selected from aromatic nylon and amorphous nylon, and
the aromatic nylon and the amorphous nylon are included in an amount of 0.01 to 30 wt % in the m-xylenediamine (MXD)-based modified nylon.

6. The polyamide-based composite resin composition of claim 1, wherein the clay is mixed clay formed by mixing two or more selected from platy montmorilionite, hectorite, saponite, and vermiculite and organically pretreating the mixture.

7. The polyamide-based composite resin composition of claim 6, wherein the organically pretreated mixed clay is formed by pre-treatment with an organic material including tertiary or quaternary ammonium,

8. The polyamide-based composite resin composition of claim 7, wherein the organic material includes one or more ammoniums selected from bis(2-hydroxy-ethyl)methyl tallow ammonium and dimethyl hydrogenated-tallow ammonium.

9. The polyamide-based composite resin composition of claim 6, wherein the organically pretreated mixed clay is formed by pre-treatment with an organic material including any one or more functional groups selected from phosphonium e, succinate, acrylate, benzylic hydrogen, dimethyl distearyl ammonium, and oxazoline.

10. The polyamide-based composite resin composition of claim 1, wherein the polyamide-based resin includes polyamide 6.

11. The polyamide-based composite resin composition of claim 1, wherein the polyamide-based resin further includes one or more resins selected from a maleic acid-based resin and an epoxy-based resin to increase a molecular weight,
a molecular weight is adjusted by an extrusion reaction between a —NH functional group at an end of polyamide and a resin including a maleic acid- or epoxy-based resin, and
the one or more resins selected from a maleic acid-based resin and an epoxy-based resin are included in an amount of 0.01 to 15 wt % in the polyamide-based resin.

12. The polyamide-based composite resin composition of claim 1, wherein the polyamide-based resin includes aromatic nylon to improve a gas barrier property, and
the aromatic nylon is included in an amount of 0.01 to 15 wt % in the polyamide-based resin.
